(19) United States
(12) Patent Application Publication
(10) Pub. No.: US 2025/0069089 A1
(43) Pub. Date: Feb. 27, 2025

(54) ARTIFICIAL INTELLIGENCE BASED SYSTEM FOR THIRD-PARTY VENDOR RISK ASSESSMENT

(71) Applicant: Debra Baker, Raleigh, NC (US)

(72) Inventor: Debra Baker, Raleigh, NC (US)

(21) Appl. No.: 18/810,832

(22) Filed: Aug. 21, 2024

Related U.S. Application Data
(60) Provisional application No. 63/578,398, filed on Aug. 24, 2023.

(51) Int. Cl. G06Q 30/018; G06Q 10/0635; G06Q 10/0639

(52) U.S. Cl. CPC G06Q 30/018; G06Q 10/0635; G06Q 10/06395

(57) ABSTRACT

The present disclosure discloses a system and method for performing third-party vendor risk assessment. The method may include gathering, by an Artificial Intelligence based system, compliance documents. The method may further include obtaining templates and artifacts having questionnaires, and using an AI Engine to analyze the gathered compliance documents and generate training data. Further, the method may include testing the training data against pre-stored trained data and outputting a filled out assessment based on the training data. The system includes an Artificial Intelligence engine and at least one memory and processor configured to perform the method.

### BACKGROUND OF THE INVENTION

### Field of the Invention

The present invention relates generally to third-party vendor risk assessment systems, and specifically to an artificial intelligence (AI) system configured to read and analyze compliance documentation in order to respond to third-party vendor risk assessments.

### Description of the Related Art

Performing thorough and exhaustive vendor risk assessment is highly important for all business establishments. This is specifically true for businesses that deal with confidential information, which may be prone to data leaks and cyber-attacks. Performing exhaustive vendor risk assessment enables businesses to thoroughly understand the vendors that the businesses may choose to engage with, and feel confident of their data security measures, legal compliance, financial stability, etc. In many industries, performing third-party vendor risk assessment is mandated by law, and hence the businesses are bound to perform the risk assessment of the vendors that they are engaging with.

Performing third-party vendor risk assessment requires analysis of a huge set/amount of documentation, which may be a time-consuming process. For example, it make take 15-20 hours or more of manual effort to perform third-party vendor risk assessment.

Therefore, there is a need for a system that assists in performing third-party vendor risk assessment quickly and efficiently.

### SUMMARY OF THE INVENTION

The following presents a simplified summary of the present disclosure in a simplified form as a prelude to the more detailed description that is presented herein.

In accordance with embodiments of the invention, there is provided a method for performing third-party vendor risk assessment. The method may include gathering, by an Artificial Intelligence based system, compliance documents. The method may further include obtaining templates and artifacts having questionnaires, and using an AI Engine to analyze the gathered compliance documents and generate training data. Further, the method may include testing the training data against pre-stored trained data and outputting a filled out assessment based on the training data.

A system, as described herein the present disclosure, learns compliance data/documentation, and automatically answers third-party vendor risk assessment. The system is Artificial-Intelligence (AI) based, and hence performs the third-party vendor risk assessment accurately and substantially faster than a human. Using the AI-based system, as disclosed in the present disclosure, the third-party vendor risk assessments may be completed in minutes and not hours (which is the time duration typically required to manually perform third-party vendor risk assessments).

These and other features, aspects, and advantages of the present invention will become better understood with reference to the following description.

### BRIEF DESCRIPTION OF THE DRAWINGS

Illustrative embodiments of the present invention are described herein with reference to the accompanying drawings, in which:

FIG. 1 depicts an example environment including an Artificial-Intelligence based system for performing third-party vendor risk assessment in accordance with embodiments of the invention;

FIG. 2 depicts documentations that may be analyzed by the system of FIG. 1 in accordance with embodiments of the invention;

FIG. 3 depicts an example system workflow in accordance with embodiments of the invention; and

FIG. 4 depicts a flow diagram of an example method for performing third-party vendor risk assessment in accordance with embodiments of the invention.

### DESCRIPTION OF INVENTION

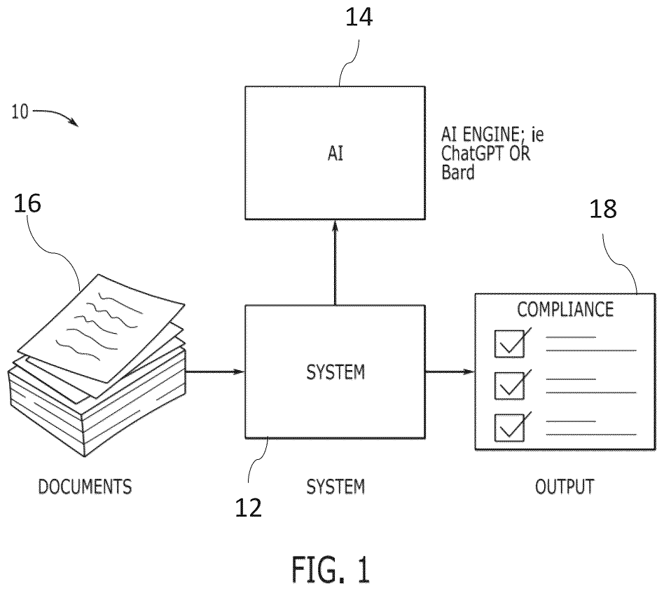

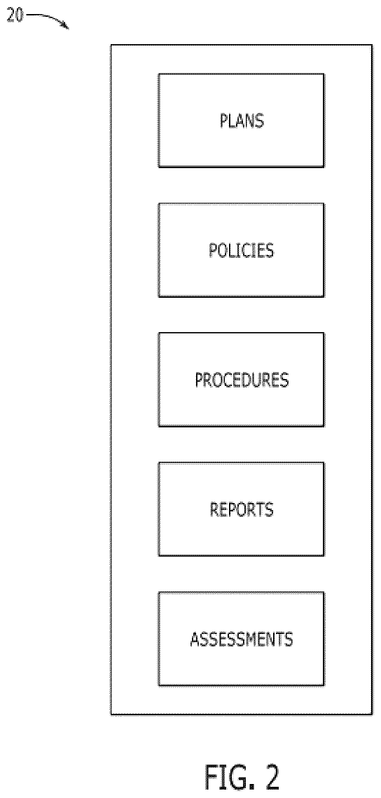

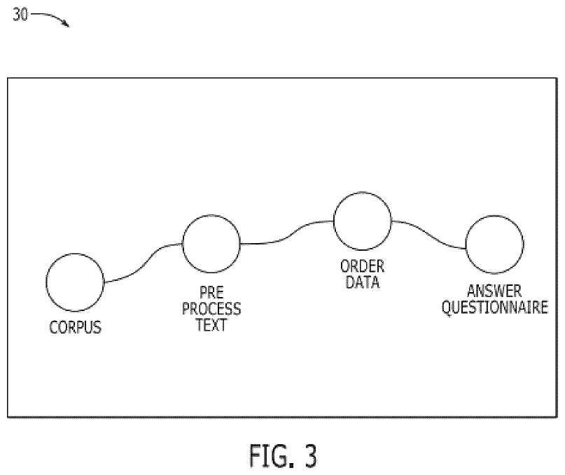

FIG. 1 depicts an example environment 10 including an Artificial-Intelligence (AI) based system 12 (or system 12) for performing third-party vendor risk assessment in accordance with embodiments of the invention. In embodiments, the system 12 can operate on one or more computers interconnected by one or more networks, or communication interfaces, through one or more servers. FIG. 1 will be described in conjunction with FIGS. 2 and 3. FIG. 2 depicts documentations that may be analyzed by the system 12 to perform the third-party vendor risk assessment, and FIG. 3 depicts an example system workflow.

The system 12 may be communicatively coupled or integrated with an AI Engine 14, which may be ChatGPT or Bard. The system 12 may use the AI Engine 14 to analyze a plurality of documents 16 associated with a third-party vendor, and automatically and quickly output third-party vendor risk assessment 18 to one or more user interfaces.

In some aspects, the system 12 may be configured to, via the AI Engine 14, analyze different types of information or data 20 (same as the documents 16) to perform the third-party vendor risk assessment. Examples of the data 20 are depicted in FIG. 2 and may include, but are not limited to, plans, policies, procedures, reports, assessments, and/or the like.

As shown in FIG. 3, as part of a high-level system workflow 30, the system 12 may first obtain and analyze a corpus of data/documents. Thereafter, the system 12 may pre-process text included in the corpus, and order any data that may be missing to fill in the gaps (as determined during the pre-processing process). In response to missing data identified in the pre-process step, the system 12 can rationalize based on the data it contains. The system 12 may then automatically answer third-party vendor risk assessment questionnaire.

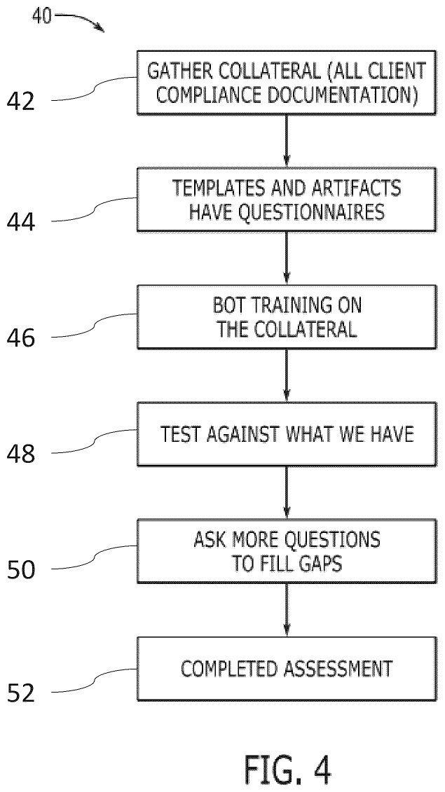

FIG. 4 depicts a flow diagram of an example method 40 for performing third-party vendor risk assessment in accordance with embodiments of the invention. At step 42, the system 12 may gather collateral, e.g., all client compliance documents, the examples of which are depicted in FIG. 2. In embodiments, gathered collateral can form the basis for assessments and questionnaires that need to be answered. In embodiments, collateral can be uploaded, or otherwise uploaded, to system 12 for processing.

At step 44, the system 12 may obtain templates and artifacts having questionnaires that the system 12 may answer. In embodiments, templates and artifacts can be provided to the system by one or more third-party vendors. For example, a third-party vendor may be concerned with security posture, vulnerability assessments, and patching cadences. The third-party vendor would then upload a questionnaire that provide questions related to security posture, whether vulnerabilities are patch, and at what cadence they are patched. In embodiments, templates and artifacts can be uploaded, or otherwise uploaded, to system 12 for processing.

At step 46, the system 12 may use the AI Engine 14 (or run a bot) to analyze the gathered collateral, templates, and artifacts, and generate training data based on the results of the analysis. In embodiments, the training data can include at least one question, and at least one answer to the at least one question. At step 48, the system 12 may test the training data against the data (e.g., pre-stored trained data) that the system 12 may already have. In embodiments, the data that system 12 may already have can include at least one model answer to at least one question. In embodiments, all data ingested by the system can be used to train and improve AI engine 14. Additionally, all data ingested by the system can be provided as feedback to the AI engine 14 in order to refine an improve AI engine 14.

At step 50, the system 12 may ask the client more questions if needed to ensure that the system 12 may answer all of the vendor questions. For example, if the system 12 needs more data to answer a specific question, if a potential answer results in an ambiguity, etc., the system 12 may query the user for additional information to resolve the issue.

At step 52, the system 12 may output the filled out assessment and questionnaire to one or more user interfaces.

The method and system, as described in the present disclosure, analyzes, learns, and orders compliance and policy data. The system 12 may learn the data in order to complete third-party vendor assessments automatically and quickly. This will aid security professionals in responding to third-party compliance and vendor assessments. The system 12 used to analyze, learn, and order may have a memory and a processing unit, as well as access to the AI Engine 14, as described above.

To assemble the system 12, a computer system with an operating system on premise or in the cloud may be required. The system 12 may have an API access to the AI Engine 14 such as ChatGPT™ or Bard™. A private instance may be trained and modeled.

To operate the system 12, a user may access the system 12 by accessing a website that may be a front end to a Software as a Service or may run the system 12 locally on a private server on the user's internal network.

In some aspects, the system 12 may additionally import and analyze lots of information and then answer a set of questions that may not be specific to compliance or third-party vendor assessments. The AI bot instance may have to be trained on the new set of data.

The system 12 may be configured to complete third-party vendor assessments, whether in custom or standard format. Using the AI-based system 12, third-party vendor assessments may be completed in minutes and not hours. Compliance artifacts may be read by a compliance-trained AI bot to automatically complete the assessment. The AI-based system 12 performs the third-party vendor risk assessment considerably faster than a human.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

In certain embodiments, the network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, Mac-OS, Windows, Unix, OpenVMS, an operating system based on Linux, or any other appropriate operating system, including future operating systems. In some embodiments, the computing systems may be a web server running web server applications such as Apache, Microsoft's Internet Information Server™, and the like.

In particular embodiments, the computing systems include a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface may include hardware, software, or both providing one or more interfaces for communication between a person and the computer systems. As an example, and not by way of limitation, a user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface.

The communication interface includes hardware, software, or both providing one or more interfaces for communication (e.g., packet-based communication) between the computing systems over the network. As an example, and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

The claimed invention is:

1. A method for performing third-party vendor risk assessment comprising:
gathering, by an Artificial Intelligence (AI) based system, at least one compliance document;
obtaining, by the system, at least one template or artifact having at least one questionnaires;
using, by the system, an AI Engine to analyze the gathered at least one compliance document and generate training data;
testing, by the system, the training data against pre-stored trained data; and
outputting, by the system, a filled out assessment based on the training data.

2. The method of claim 1, wherein the at least one compliance document is one of:
structured data, or unstructured data.

3. The method of claim 1, further comprising:
analyzing, by the system, the at least one compliance document.

4. The method of claim 3, wherein the wherein analyzing, by the system, the at least one compliance document further comprises:
pre-processing the at least one compliance document;
determining, based on the preprocessing, at least one missing data;
retrieving, by the processor, the at least one missing data.

5. A system for performing third-party vendor risk assessment comprising:
at least one Artificial Intelligence (AI) engine; and
at least one processor, and at least one memory storing instructions that when executed by the at least one processor cause the processor to perform a method, the method comprising:
receiving, by the at least one processor, at least one compliance document;
analyzing, by the at least one processor, the at least one compliance document;
obtaining, by the at least one processor, at least one of a template or artifact having at least one questionnaire;
analyzing, by the at least one AI engine, the at least one compliance document;
generating, by the at least one AI engine, at least one training data based on the results of the analyzing;
testing, by the processor, the at least one training data against at least one pre-stored training data;
outputting, by the processor, at least one auto populated assessment based on the at least one training data.

6. The system of claim 4, wherein analyzing, by the processor, the at least one compliance document further comprises:
Pre-processing the at least one compliance document;
Determining, based on the preprocessing, at least one missing data;
Retrieving, by the processor, the at least one missing data.

7. The system of claim 4, wherein the AI engine is an AI bot trained on at least one compliance data.
